(19) United States
(12) Patent Application Publication
(10) Pub. No.: US 2005/0060754 A1
(43) Pub. Date: Mar. 17, 2005

(54) Apparatus and method for distributed control of media dissemination

(75) Inventor: Jeffrey A. Simyon, Alpheretta, GA (US)

Correspondence Address: HUSCH & EPPENBERGER, LLC, 190 CARONDELET PLAZA, SUITE 600, ST. LOUIS, MO, 63105-3441, US

(73) Assignee: Wegener Communications, Inc., Duluth, GA (US)

(21) Appl. No.: 10/665,096

(22) Filed: Sep. 17, 2003

(51) Int. Cl. H04N 7/173; G06F 15/16

(52) U.S. Cl. 725/112; 725/110; 725/109; 725/105; 709/227

(57) ABSTRACT

A control system for media content data broadcast has a master control processor operatively associated with a web server, each having communication links to a computer network. At least one uplink, remote from the master control processor, is operatively connected to the same computer network. The master control processor and web server are configured to receive control instruction requests from a browser through its communication link with the computer network. The control processor is configured to generate a control instruction command for controlling transmissions made by the uplink(s) by sending to the uplink(s) a control instruction command through the computer network.

### CROSS-REFERENCE TO RELATED APPLICATIONS

None.

### STATEMENT REGARDING FEDERALLY SPONSORED RESEARCH OR DEVELOPMENT

Not Applicable.

### APPENDIX

Not Applicable.

### BACKGROUND OF THE INVENTION

1. Field of the Invention

The invention is in the field of media dissemination, particularly satellite broadcast of media content data such as audio and video together with the methods and apparatus for controlling the medial dissemination.

2. Related Art

The dissemination of media content data, such as audio and video programming, requires a certain degree of control over both the programming and its transmission. The disseminated media content itself must be controlled in terms of program selection, scheduling and the like. In dissemination systems, such as satellite broadcasting to multiple receivers, transmission must also be controlled. For example, the individual receivers or groups of receivers that are to receive a particular program must be identified, and those that are not must be excluded. A wide variety of parameters may be controlled, see for example, U.S. Pat. No. 4,985,895 Pelkey, which is incorporated by reference herein. Generally, a greater degree of control is desirable.

Historically, transmission of media content data up to a communication satellite for rebroadcast to receivers has been through a central uplink transmitter. Control was had through an operator of a control computer at the central uplink. That computer would be linked with storage databases wherein various programs were stored as media content data. Usually content data files were stored in association with the owners of the rights to that programming, such as cable news services, traditional broadcast television businesses or music distributors. The control computer would receive an operator's instructions on various control parameters such as scheduling, transmission frequency, channel selection, regional distribution, interrupt priorities for adverting and the like. The control computer would package a transmission of content data along with instructions for controlling its play. These data packages would then be multiplexed, encoded and sent for uplink transmission to a satellite for distribution. The content data and control instruction data would be multiplexed and encoded according to protocols such as DVB. Finally, the package of programming would be broadcast to multiple receivers which would receive the control instructions with the programming and execute them.

Owners of programming and users of the satellite broadcast services would need to communicate with a human operator at the uplink control system in order to convey the control parameters desired. In order to communicate with the control programmer when uplink transmission was executed by a single uplink, the user would need to make a telephone call, fax in instructions or, as later developed, send instructions by separate email. As programming and the amount of control parameters available proliferated, this system became increasingly burdensome for both parties.

Dissemination systems such as satellite broadcast have developed to a stage where multiple uplinks are used for transmitting programming to a satellite for redistribution. Uplinks are generally equipped with their own control capabilities. That is multiple uplinks, even uplinks on television news trucks, will have computer hardware within each uplink with a user interface through which control parameters may be entered. The development of multiple uplinks allows a greater degree of access to users with regard to control of programming being transmitted by the uplink to the satellite. However, the multiple uplink control capability remains expensive in that a great deal of hardware, software, software installation cost and maintenance cost is required at each uplink in order to achieve the media control desired by users.

Sharing control software and functionality among multiple uplink transmitters would represent a corresponding cost savings, as compared to duplicating control software at each uplink. A shared control of multiple uplinks may be had through the Internet. Use of the Internet also allows hitherto unused bandwidth sources to be used to facilitate uploads of large media content files such as video and audio.

There is a need in the industry for a system to distribute control capabilities to a large number of users of a media content data dissemination system such as satellite broadcast system. There is a further need for such a system to control transmissions by multiple remote uplinks. There is a need to do so in a fashion that does not require duplication of expensive hardware for each uplink available to a potential user.

### SUMMARY OF THE INVENTION

It is in view of the above problems that the present invention was developed. The invention comprises a central control system operating within a satellite communication environment and commanding multiple remote uplinks, including “slave” uplinks over a network, such as the Internet. Control instruction commands are distributed to the “slave” uplinks from a central control processor, reducing the need for control processing hardware and software at each uplink.

With the distributed broadcast control system the users of media dissemination systems, such as satellite broadcast systems, can access central control computing hardware via a computer network such as the Internet. Through an appropriately secured website having compartmentalized and secured access pages, each user may call up control parameter fields on his page and fill them with control instructions. The instructions are sent by HTTP through the computer network to a master control computer in operative communication with an Internet Service Provider (ISP).

The master control processor operates with a web-server and communicates with it in TCP. Each would be secured behind appropriate firewalls. Communications from user accessed web-browsers through known protocols such as HTTP would be received, processed through the master control processor and redistributed to appropriate uplinks for transmission thereby up to a satellite for rebroadcast to receivers.

In one aspect of the invention, the master control processor at an ISP redistributes control instructions in batch mode via email. Batch mode avoids problems inherent with reliable streaming over Internet channels. Likewise, the use of email avoids firewall problems. The control instruction commands would be received by one or more remote “slave” uplinks. The “slave” uplinks would be capable of receiving and re-transmitting the control instructions, along with the appropriate programming, up to the satellite for rebroadcast. The “slave” uplinks would thereby become economical in that the hardware, and maintenance software necessary for database storage and retrieval would not be required at each individual uplink. Of course, the capability remains for more sophisticated uplinks with greater computing hardware associated with them to also receive the remotely entered control instructions from the master control computer at the ISP.

The commands may be distributed using an email return path for confirmation of receipt. The system and method may seek to save administrative costs by utilizing central database management. The central control system may monitor and adjust the database comprising values harvested from each “slave” server. Depending upon database values and/or human inputs, individual or groups of “slave” servers are sent commands over the network.

Further features and advantages of the present invention, as well as the structure and operation of various embodiments of the present invention, are described in detail below with reference to the accompanying drawings.

### BRIEF DESCRIPTION OF THE DRAWINGS

The accompanying drawings, which are incorporated in and form a part of the specification, illustrate the embodiments of the present invention and together with the description, serve to explain the principles of the invention. In the drawings:

FIG. 1 is a schematic view of a media content data broadcast system.

FIG. 2 is a schematic view of a receiver.

FIG. 3 is a schematic view of the distributed control system of the present invention.

FIG. 4 is a schematic view of a master control processor associated with a web server at an Internet Service Provider (ISP).

FIG. 5 is a schematic view of a web server at an Internet Service Provider (ISP) associated with a master control processor.

FIG. 6 is a schematic diagram of a remote slave uplink.

FIG. 7 is a schematic diagram of a conventional remote uplink.

FIG. 8 is a flow chart of user interaction with a central control processor for control instructions.

FIG. 9A-D are examples of a browser screen comprising a user interface at a browser.

FIG. 10 is a flow chart of a master control processor's command processing.

FIG. 11 is a flow chart depicting the creation of a batch control instruction command email.

FIG. 12 depicts the format of the batch control instruction command email.

FIG. 13 is a flow chart of a “slave” uplink's command processing.

FIG. 14 is a flow chart of a control instruction packet assembly process.

FIG. 15 is an illustration of a control instruction packet.

### DETAILED DESCRIPTION OF THE PREFERRED EMBODIMENTS

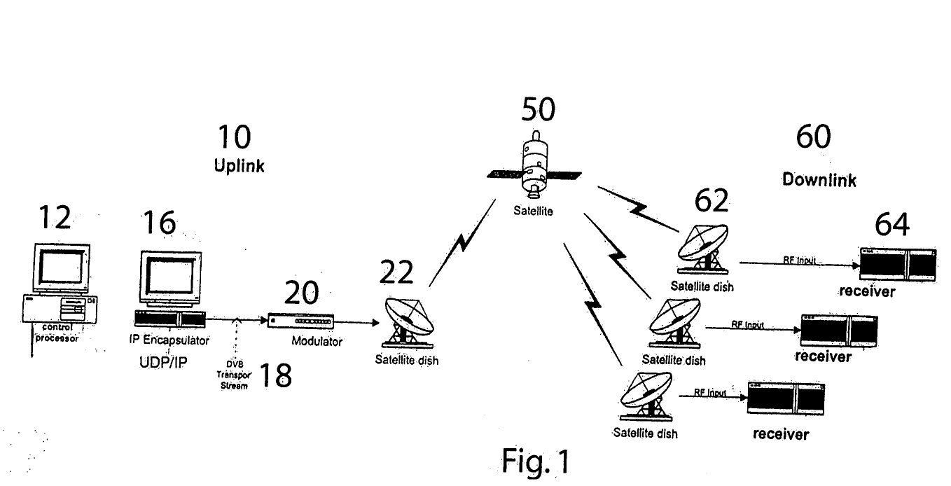

Referring to the accompanying drawings in which like reference numbers indicate like elements, FIG. 1 is an overview of a satellite broadcast, media content data dissemination system. Satellite 50 receives media content data transmissions from an uplink 10 and rebroadcasts them for receipt by downlinks 60. The digital data in the RF transmission is formatted according to known protocols such as the DVB standard, as is more fully described in U.S. patent application Ser. No. 10/382,389 to Pelkey et al., filed Mar. 6, 2003 incorporated by reference herein. At multiple downlinks 60 satellite dishes 62 receive the broadcast transmission from the satellite 50. Each satellite dish 62 inputs the received transmission into receiver 64.

The media content data digitized according to MPEG or other protocols are known in the industry as digital video broadcasting transport streams or DVB. It is more fully described in U.S. patent application Ser. No. 10/368,546 to Livaditis et al. filed Feb. 18, 2003 incorporated by reference herein.

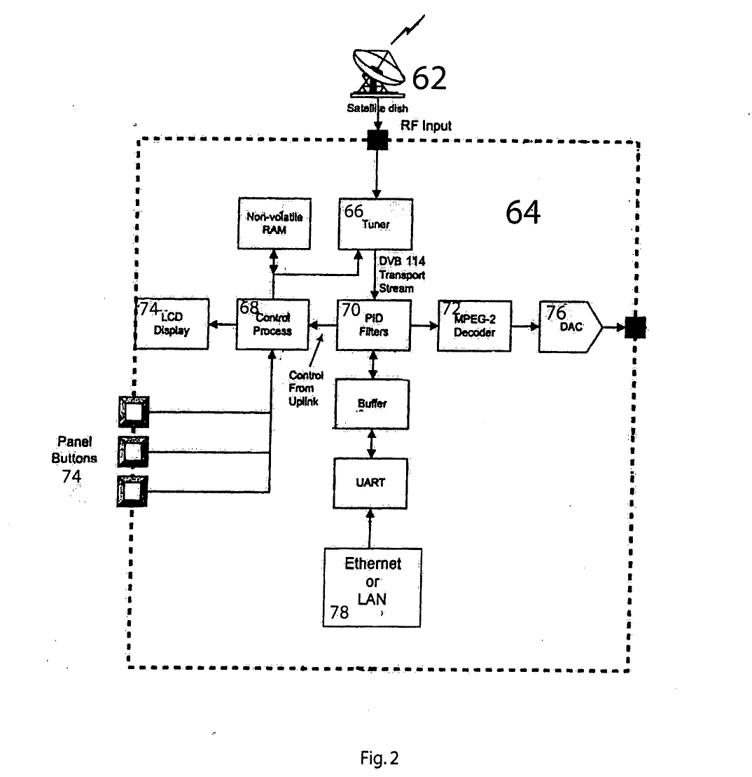

FIG. 2 depicts the components of each receiver 64, including a tuner 66, control processor 68, packet identifier filters 70, MPEG decoder 72, operator interface panel 74, digital analog converter 76 and Ethernet or LAN connection 78, together with other components used to execute the receipt, demultiplexing, decoding, conversion and transmission of the content data such as video or audio onward to performance devices such as television screens or speakers. This process is described in greater detail in U.S. patent application Ser. Nos. 10/350,930 to Blackburn et al. filed Jan. 24, 2003 and 10/400,972 to Blackburn et al. filed Mar. 25, 2003 incorporated by reference herein.

Control instructions govern the operation of these receivers. Control instructions are described in greater detail in U.S. Pat. No. 4,985,895 to Pelkey, incorporated by reference herein. Generally, control instructions are broadcast among the media content data packets, and control what programs or advertisements are played, at which receivers, over what channels, at what volumes, and the like.

The uplinks 10 are comprised of the following components, shown in FIG. 1. A satellite dish 22 is used to transmit the DVB bitstream on an RF signal up to satellite 50. Prior to that, the signal is modulated with a modulator 20. Prior to that the DVB stream is created from digital data in the UDP/IP protocol at encapsulator 16. Multiplexing is also performed at encapsulator 16.

Each uplink is also associated with a control processor 12. A control processor is used to receive control instruction inputs. The control instructions are associated with each media content data transmission, and govern parameters of its performance, including location, scheduling, content variables such as advertising or closed captioning and other parameters more fully described below.

The control processor 12 and the software it runs are relatively expensive. It encompasses a processor supplemented as needed by custom designed components. Historically, a separate control processing computer has been required at each uplink. It is the advantage of the present invention that uplinks may be more economical to produce, purchase and use without the full control processing hardware, provided that there is a link to full control processing elsewhere.

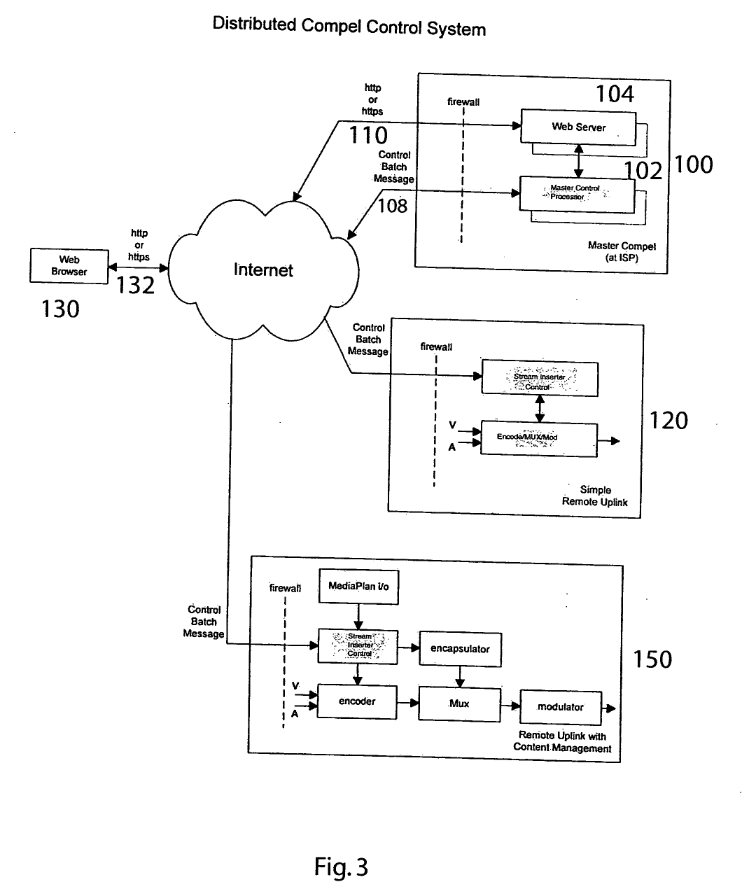

In the embodiment depicted in FIG. 3, control processing is had at a master control processor (MCP) associated with a web server at an Internet Service Provider (ISP). This web server will be referred to herein as the master control web server (MCWS). These components, combined with their associated firewalls, comprise a master control assembly 100. Within the assembly are master control processor 102, master control web server 104 and firewall 106. The master control processor 102 links through firewall 106 with a distributed computer network. In the depicted embodiment the distributed computer network is the Internet. The link 108 between the master control processor and the Internet is according to any known appropriate protocol. In the depicted embodiment, the SMTP protocol is used to gain the benefit of compatibility with existing firewalls. Alternatively, other protocols such as HTTP, FTP, TFTP etc. may be used.

Web server 104 also links with the Internet through link 110, also through known protocols such as HTTP.

The master control processor 102 will receive control instruction requests as input by users at their web-browsers 130 that are connected through web-browser link 132 and web server link 110 with the master control processor 102. The master control processor will build control instruction commands and send these commands to one or more appropriate uplinks 120, 150 through the Internet via the master control processor link 108. The remote uplinks 120, 150 remove the control instruction commands from their email encapsulation, process them as if they have been generated by a control processor at the uplink itself, and transmit the control instructions and associated media content data for broadcast to the satellite.

Uplinks may be relatively simple as that depicted at 120, but also may incorporate a range of hardware and software capabilities that are more complex, as in previous uplinks like uplink 150, which shall be described in greater detail below.

Thus in the system of the present invention, the control instructions will be embedded, sent and re-embedded three times before their execution at the ultimate receiver. That is, a user will access a web browser, call up the appropriate page, within the page call up the control parameters through control instruction fields and, after having specified the control instructions desired, those control instructions will be embedded in a control instruction request HTTP transmission through the Internet to the master control.

Upon receipt of the control instruction request the control processor will remove the control instructions from that HTTP transmission, and build those control instructions into a control instruction command for execution by an uplink. The control instruction commands will thereafter be embedded in an email to be sent by the control processor via the Internet to any particular remote uplinks. The remote uplinks will thereafter remove the control instructions from the control instruction command, insert them into a digital video broadcast bitstream during encoding of that bitstream for broadcast and the control instructions will thereafter be transmitted by the uplink to the satellite in a manner as if the control processor and user were at the uplink itself. Finally, the receivers will receive the control instructions in the DVB bitstream and execute them.

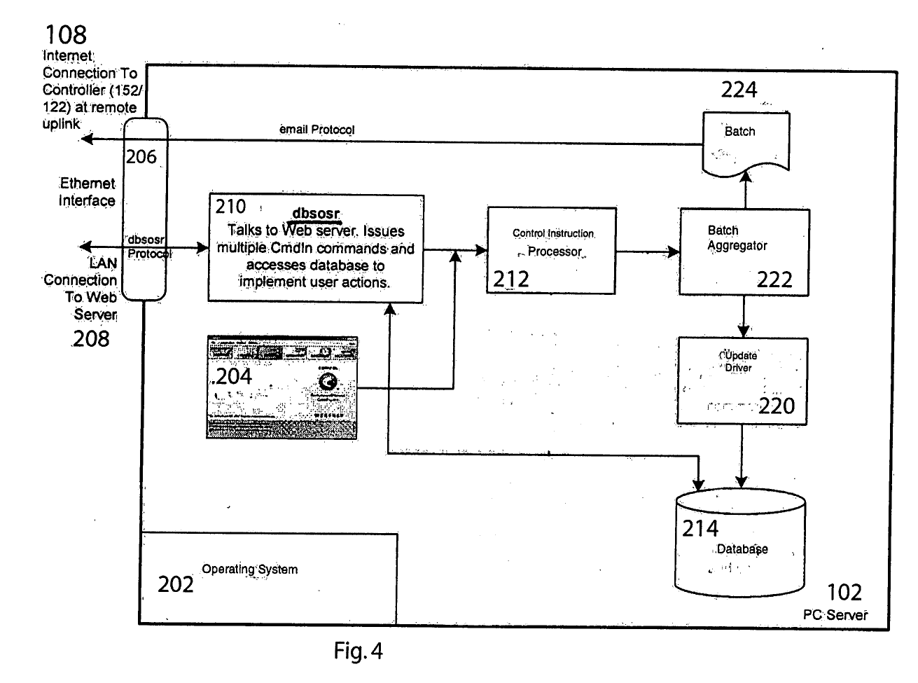

FIG. 4 is a schematic block diagram of the master control processor. This MCP, located at the MCWS will be capable of shared usage by multiple users at remote multiple web-browser links. The MCP will receive command instruction requests, repackage them and forward them to multiple uplinks. Through the multiple uplinks, the command instructions themselves will be transmitted via satellite for control of further multiples of transmission receivers. The MCP in the depicted embodiment is a computer operated by a standard operating system, such as Unix 102. Of course the MPC will have its own Graphical User Interface (GUI) 204 for use by an operator at its physical location. In order to receive command instruction requests from a user at a remote browser, the MPC 102 has an Ethernet interface 106 facilitating a LAN connection to the web server 104. Control instruction requests received from a user at a remote browser will be received from the web server 104 via a database socket server 210. The database socket server 210 is operated according to a database socket server protocol, which may be tailored to a particular web site server. The database socket server 210 will examine incoming control instruction requests and forward them to the control instruction processor 212. Control instruction processor 212 may also receive communication and control instruction requests from local GUI 204. The database socket server 210 also has access to a memory 214 comprising a database of receiver status, user status and other information. The communication between database socket server and memory 214 is two way, in order that the database socket server 210 may retrieve information regarding receiver status or user status and also so that it may update the information stored there.

A database update driver 220 records the status of receivers, in order that the memory 214 may remain current as commands which affect receiver status are sent over the system. The database update driver 220 receives this data and updates the memory when the control instruction command batch is sent.

The control instruction processor 212 further builds a control instruction command Batch for emailing to an uplink, in a manner more fully described below. The commands are aggregated in a batch aggregator 222. The aggregation of control instruction commands is retained until completely built at 224 and then emailed to the appropriate uplinks through internet connection 108.

The MCP 102 is in operative communication with a master control web server 104. The MCWS provides a user's browser access via the Internet. The web site is implemented by a combination of HTML files which the user's browser can interpret and render directly and active functions provided by Perl common gateway interface (CGI) scripts. The CGI is an interface by which the MCWS 104 is connected to an external application, in this case directly to the MCP 102. Perl Common Gateway Interface scripts may also provide active functions. Any language may be used to pass information between the MCWS 104 and MCP 102 through this CGI, including Perl, TCL, C, C++, visual basic or other appropriate languages.

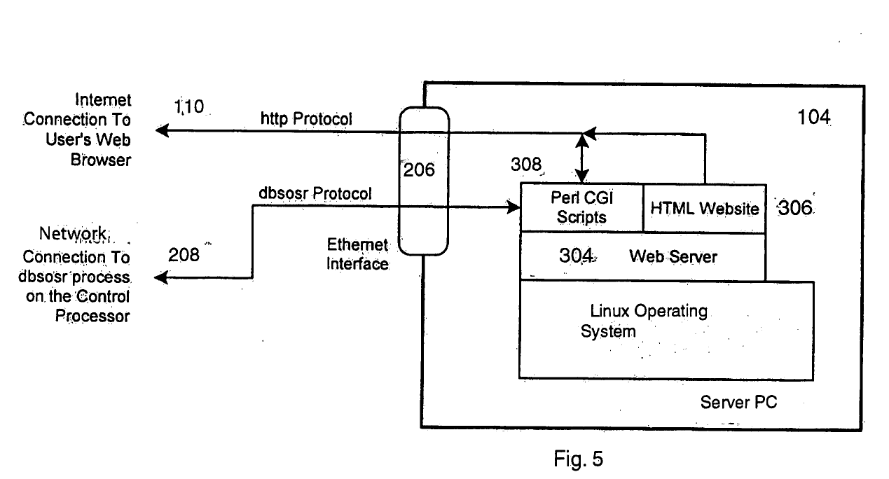

As illustrated in FIG. 5, within the MCWS, operated by a Linux or other compatible operating system, is web server 304, and which supports the web site composed of 306 and 308. This web site interacts with the users' browsers via the Internet entering through HTTP protocol 110, and through Ethernet interface 206 and firewall 106. The web site Perl CGI scripts are also in operative communication with the with the MCP 102 via connection 208 through Ethernet interface 206.

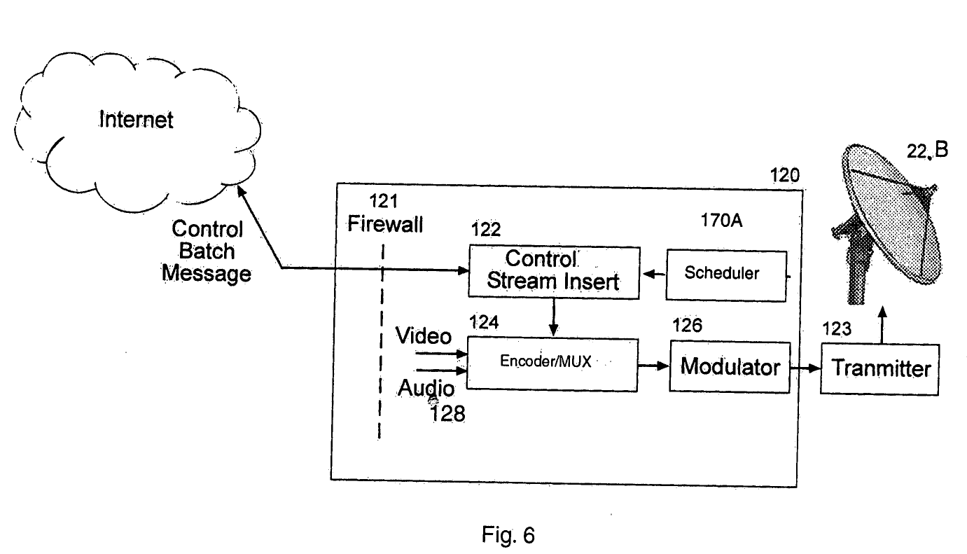

FIG. 6 depicts a simple “slave” remote uplink 120. One advantage of the system and apparatus of the present invention is that this remote “slave” uplink is simpler and more economical then prior art uplinks in that it requires less hardware and software for operation and Database and maintenance costs are lower. It may be operated by the MCP at a master control web server. The MCP may be shared for control of multiple slave uplinks. Such sharing saves the cost of separate control hardware and software for each uplink.

Simple remote uplink 120 includes a control stream inserter 122. After a control instruction command is received by email from the Internet and is passed through the appropriate firewall 121 the control stream inserter processes the email in order to extract its control instruction commands and return a confirmation of receipt. Control instructions from the control instruction command email are then inserted directly into encoder/multiplexer 124 where they are included with the digital video broadcasting (DVB) transport bitstream being encoded there. Once multiplexed with the overall video and audio DVB transport stream, the control instructions with the transport stream are modulated 126 and transmitted by transmitter 123 through uplink dish 22A.

The actual media content data is input at audio/video input 128. A large amount of the time, remote slave uplinks will be used for such things as a live feed for news services and the like. Accordingly, audio/video input 128 at remote uplinks will frequently come from a connected live feed. However, it is possible to upload media content data to slave uplink 120 from other sources. These may be hardware sources connected to the remote slave uplink, but may also be transmitted from sources elsewhere stored and connected with the remote slave uplink 120 through a computer network such as the Internet.

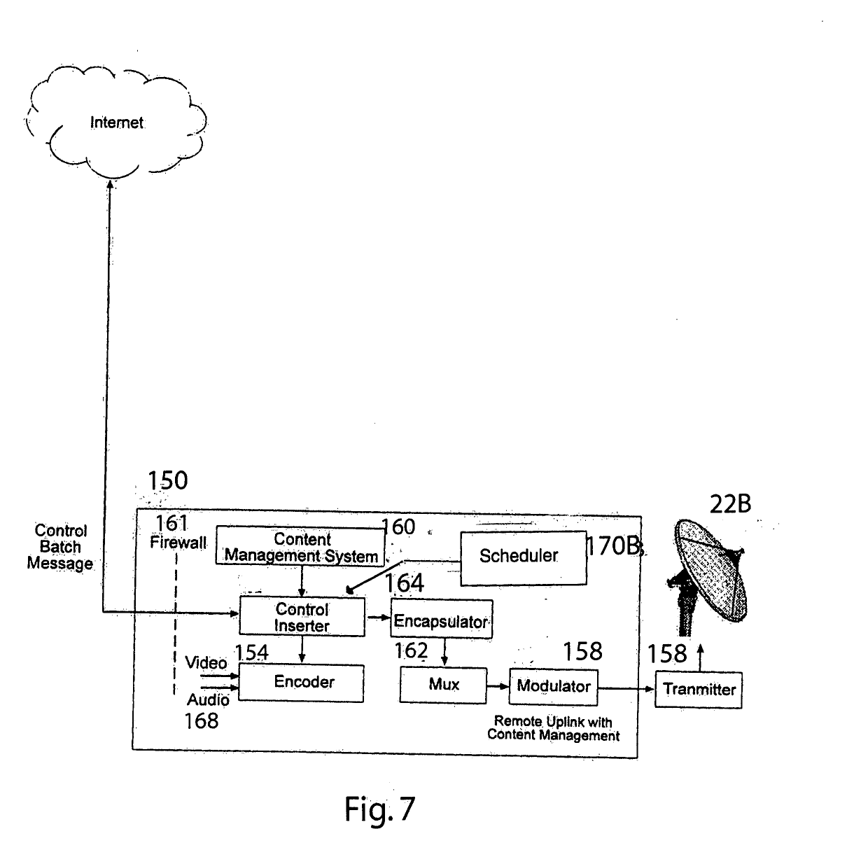

A separate memory 170A, 170B, FIGS. 6 and 7, respectively, stores a database of scheduled control instructions in the depicted embodiment, and forwards the control instructions to the control stream inserter 122, 152, at the appointed time. Schedule instructions may be periodic. Optionally, scheduled instructions may be stored and may also be inserted in a digital data stream at the MCP.

Of course the system and method and the method of the present invention is compatible with use of conventional uplink equipment. Accordingly, as shown in FIG. 7, a familiar complex remote uplink 150 with full content management hardware 160 may also receive control instruction commands through its firewall 151. Those too will be unencapsulated from the email at control stream inserter 152. These will be inserted in a similar fashion by encapsulater 164 and multiplexer 162 into the video and audio bitstream. They may additionally or alternatively be encapsulated by encapsulator 164 and thereafter multiplexed 162 before being modulated 156 and transmitted 158 through uplink dish 22B. As with the slave uplink 120, the standard uplink 150 may also receive audio/video media content 168 from any source, including uploading from elsewhere on the Internet, local storage in the memory (not shown), uploading through a local LAN from a locally stored memory (not shown) or from a local live feed.

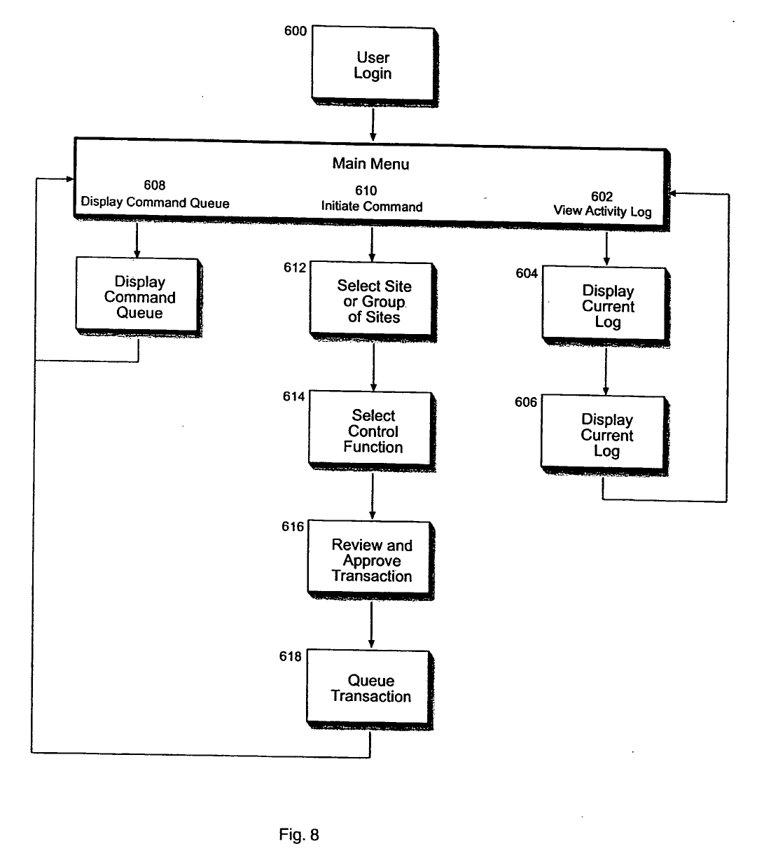

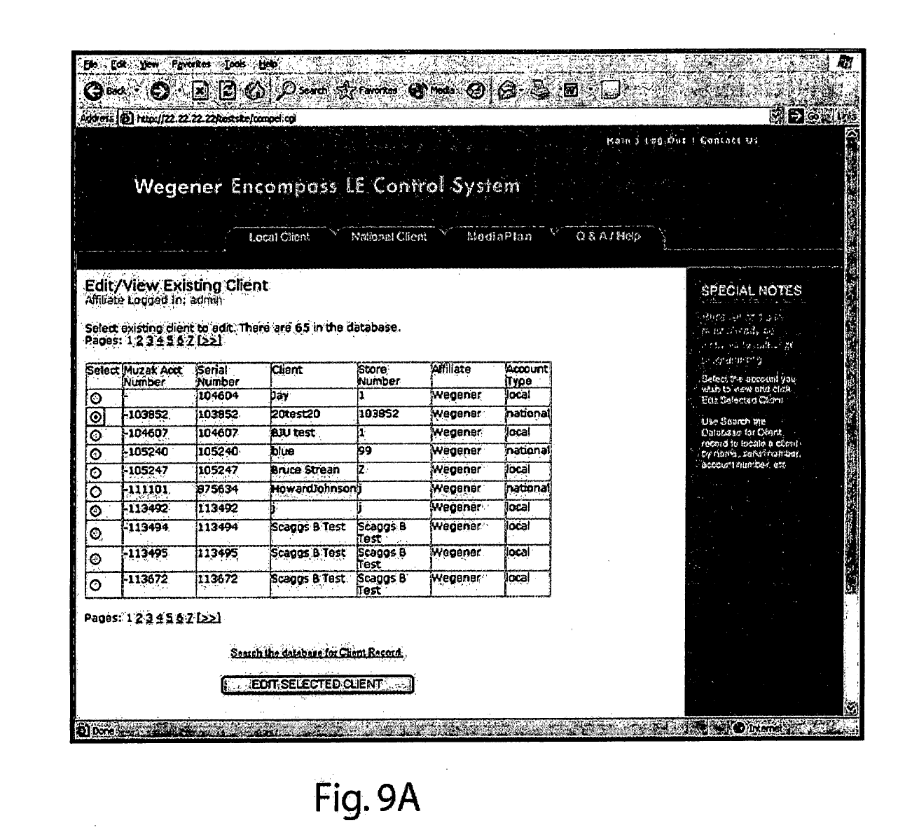

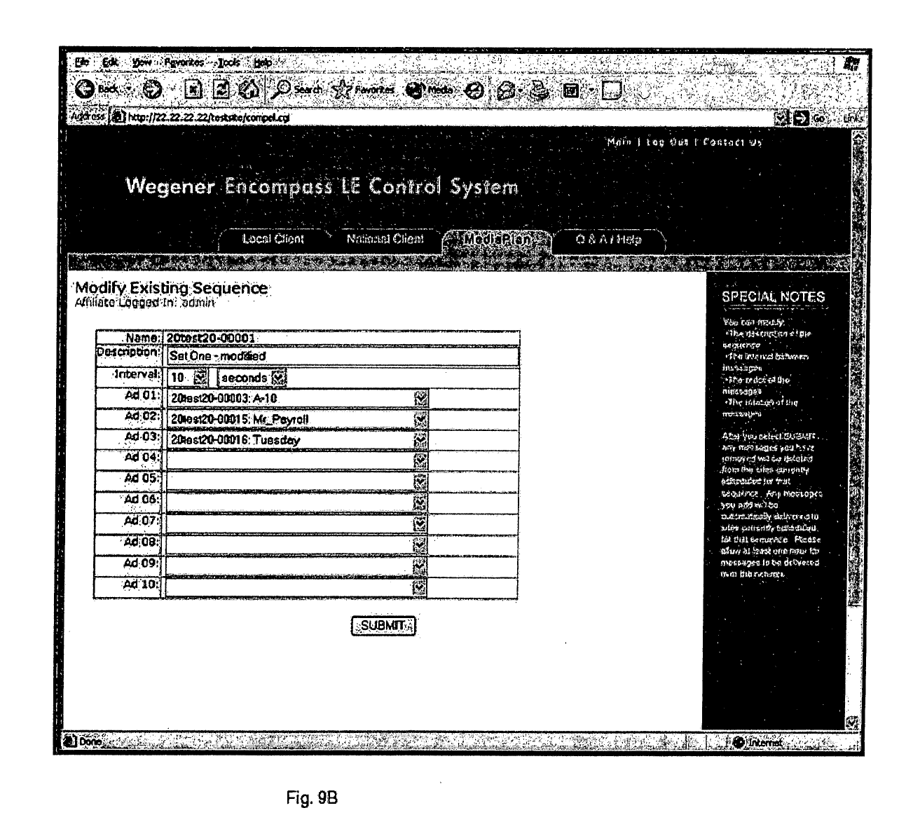

In operation, a user at any computer that is connected with a computer network such as the Internet via a web browser or other means, may control programming. FIG. 8 is a flow chart of user interaction with a central control processor for control instructions. A user links to the master control processor site and logs on 600. By entering a user ID and password, the user accesses a page linking to that user's designated memory storage. Each user's memory will contain their unique media content data and previously stored or default control instructions.

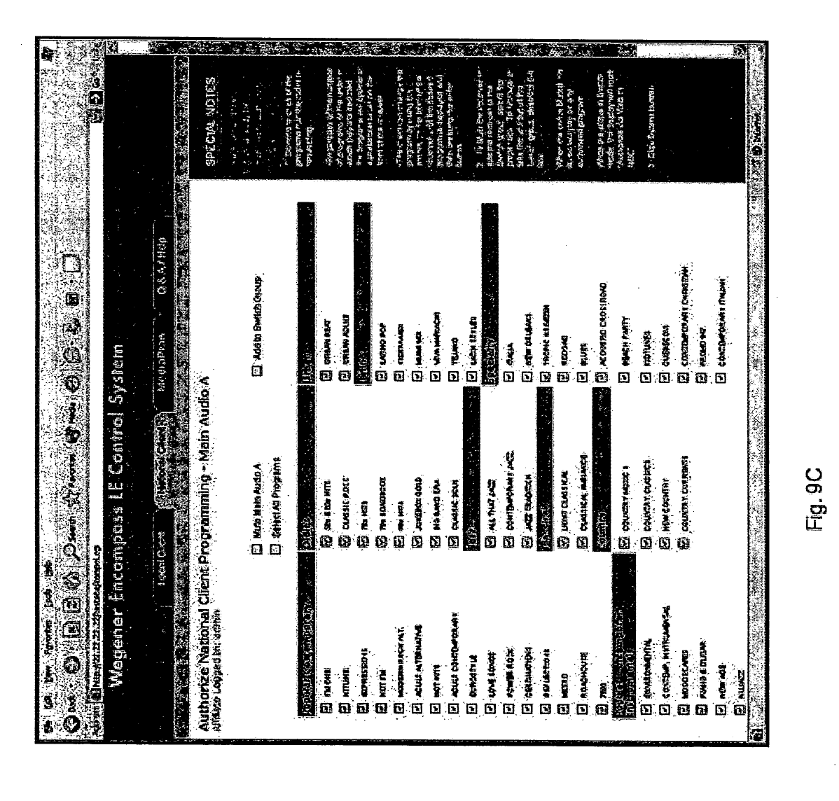

Each page has a main menu. From the main menu, the user can access her activity log 602 to display a log of current control parameter settings 604. The user can search for individual parameters, the instructions previously set in them, and/or the media content data, all of which are stored in memory. FIGS. 9A through 9D illustrate the examples of various screens presented to a user on their browser from the MCWS. The data within the format of the screens is called up from the MCP status memory 214 and inserted for display on the screens. The user may also display the command queue 608 to check the processing of instructions.

In order to execute control instructions, the user initiates the command process 610 after logging on 600. Again, logging on 600 includes not only the user logging onto the internet and going to the appropriate distributed control system website, but thereafter using a unique user name and password to access that user's compartmentalized and secure page within the site. Messages between the user's point of access and the ISP where the master control processor resides are encrypted according to known techniques. The present invention may be executed with the use of any encryption, authentication or other security techniques. A display of parameter fields that may be controlled is called up. Some parameters must be entered, such as selection of the site or group of sites (uplinks) 612 to whom the control instruction commands will be applied. FIG. 9A illustrates an example of a screen for user interaction at a browser. It is used to select a receiver to be controlled. The control instruction parameters themselves are then displayed, and those that are to be used are selected 614. FIG. 9B illustrates a screen showing parameters to be controlled, advertisements in the example, with drop down menus for available advertisements, intervals for play, and the like.

When selected a field appears for the control parameter. The user interface can use any format, including the already known formats of drop down menus, check boxes, or blank fields in which instructions may be keyed in by a user. Other formats are possible. FIG. 9C illustrates an alternative format, with check boxes. After keying in all the control instructions the user deems necessary, a review window is displayed that summarizes the entered instructions, together with any default instructions and/or cues for additional instructions that may be necessary for system execution. If the user approves of the control instructions as summarized in the review screen 616, the user may enter the control instructions. FIG. 9D illustrates a summary and confirmation screen. At that point, the entire transaction is encapsulated in an HTTP transmission for sending to the MCWS and the associated master control processor, and the transaction is queued for execution there. This HTTP transmission is the control instruction request.

The HTTP transmission will be configured, formatted and sent according to known HTTP protocols commonly used for communication between web browser displays and the webs servers with which they are connected. Within this HTTP transmission structure the data reflecting the user's choices will include a receiver address identifying a particular receiver at which a control instruction is to be executed. The transmission will also include a device address, identifying the component of the receiver that is to execute the control instruction. It will also include the “command” which defines the parameter to be controlled. Finally, it will include the “data” which is the parameter level or option to be executed. For example, if a music subscriber wants to change the volume at which the music is playable at a receiver, the data would be the volume level, the control instruction parameter would be the audio level at the receiver, the device would be the MPEG decoder and the receiver would be the particular receiver at which the instruction is to be executed.

At the main menu 616 the user may select to display the command queue. If so, the command queue will be displayed 608. Thereby, the user may view all entered control instructions for that user's programming. This screen will display all control instruction sets that have been entered for that user. Optionally, this may also display scheduled control instructions and/or default control instructions that will automatically be generated at the control processor and be executed in any given time frame.

Of course, a single user may control a great deal of programming. It is within the scope of the present invention that the user's secure page within the systems' master control website may be further subdivided into a scaleable number of pages. The organization of these pages may also vary and remain within the scope of the present invention. For example, pages may be organized according to a particular customer, cable provider, channel, broadcast satellite or even by program. In a similar manner, both the command entry procedures under main item number 610 and the display command queue format under main item 608 may be organized in a variety of ways.

In addition to displaying an active command queue, a database may be maintained and displayed as an activity log to include past control instruction entries. A user may view this by selecting the view activity log portion of the main menu 620 and thereafter the screen will display the current log of control instruction entries 604. This feature may be searchable 606. The format and technique of searching maybe broadly variable and remain within the scope of the present invention.

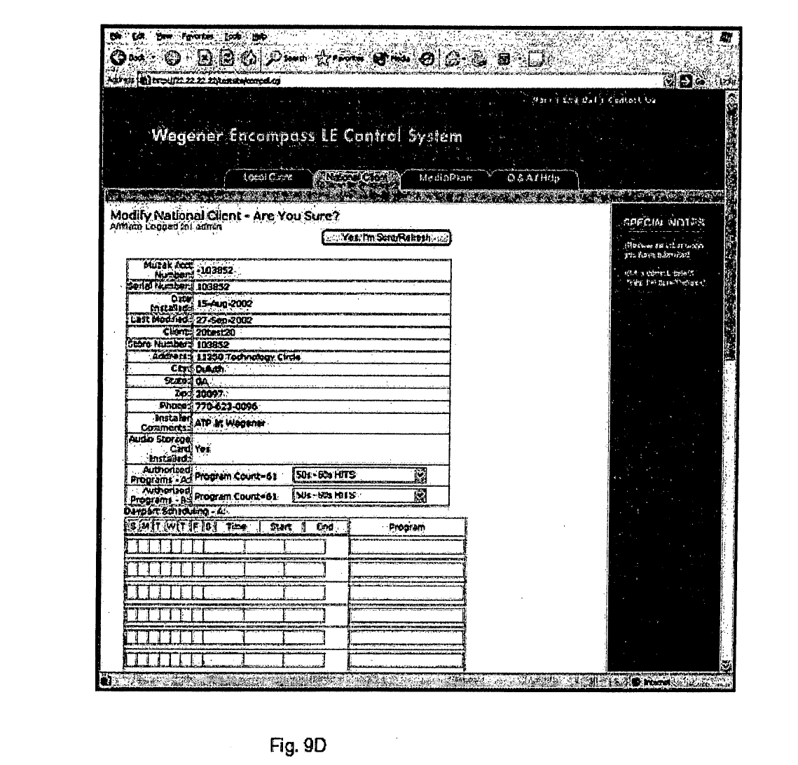

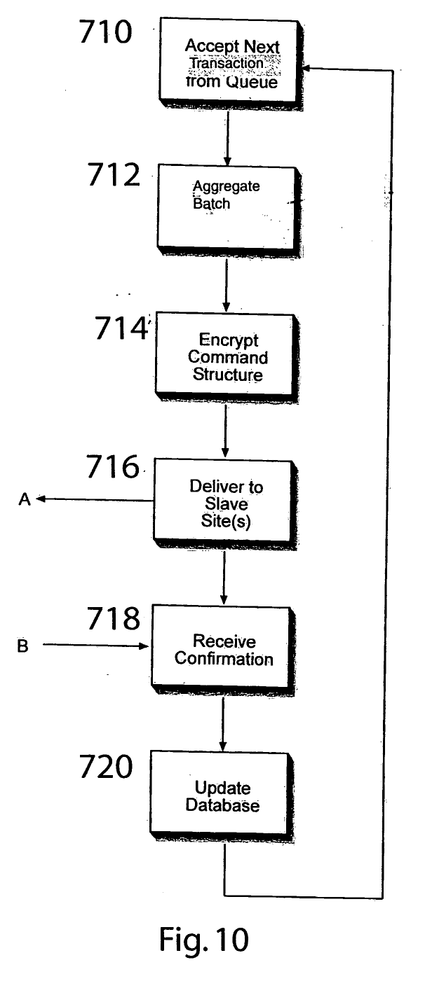

Processing of the control instruction requests is described in FIG. 10. The master control processor 102 receives the control instruction requests from a queue generated at the MCWS 104. The central control processor first accepts the next transaction from the queue 710. Thereafter, it will build a control instruction command, as described below, and aggregates a batch email 712. That control instruction command will be encrypted 714 and then delivered to the appropriately addressed “slave” uplink(s) 716. This control instruction command will also be encapsulated in an email, preferably in batch form, although session format and other formats remain within the scope of the present invention. The email of the control instruction command in the depicted embodiment includes a request to confirm receipt. Receipt can be confirmed by a simple indication that the email has been received at the uplink. In embodiments discussed herein, the receipt confirmation would include substantive confirmation that the control instruction command was not only received but unencapsulated from its email and checked for integrity in its internal structure, as by a check sum or cyclic redundancy check, for example.

Upon receipt of confirmation 710 that the uplink has properly received the control instruction command, the central control processor updates its database 20. If no confirmation is received, the control instruction remains queued at MCP/102 to be resent. This database will include a memory logging chronologically all control instruction requests and their corresponding control instruction commands. An associated database or the same database may also store control instructions that are to be executed later or repeated, as by a scheduling instruction. In the depicted embodiments, the associated schedule databases are maintained at the uplinks. These databases may be further supplemented as appropriate to record data such as historical information on number of uses, control parameters selected, surveying information, marketing information, and billing information.

The format of the control instruction requests generated and queued by database socket server 210 is address/device/command/data. The information used to generate the control instruction requests was received by the web server in http format and sent from the web server CGI in Perl script to the database socket server 210. The database socket server 210 outputs to processor 212 in ASCII format.

The address identifies the receivers or group of receivers to receive a control instruction. For example if the individual integrated receiver/decoder number 101 is to receive a particular set of control instructions, the database socket server will forward to the processor 212 “IRD 101.”

As illustrated in FIG. 2, each IRD is comprised of multiple components. These components or “devices” may be controlled by transmitted control instructions. In order to do so they must be identified. Accordingly, the device portion of the control instruction format identifies the device within the receiver to be affected by the command. For example, if the command is to be executed by the MPEG decoder, the device portion of the control instruction format will read “MPEG.”

The parameter that the control instruction to be executed upon is identified in the “command” portion of the control instruction format. For example, if the audio loudness of the decoder is to be changed, a command portion of the control instruction format would read “audiolevel.”

Finally, the data portion of the control instruction format identifies the selected parameter level or option to be executed by the control instruction. Accordingly, in the example, if the audio level of port 1 is to be set at six decibels, this portion of the control instruction format would read “1, 6.” The entire control instruction format as illustrated by the example would be “IRD 1/MPEG/AUDIOLEVEL/1, 6.”

Hence, as prompted by the incoming HTTP message containing user selections from the user's web browser, the database socket 210 server will call up the relevant receiver serial number from memory 214 and format the control instruction for them as described above.

Processor 212 retrieves from database 214 the serial numbers of the relevant addresses identified in the control instruction as received from the database socket server 210. The processor 212 may be a separate component from the batch aggregator. For example, this may be the case if the system and method of the present invention are built for compatibility with preexisting uplinks, or adapted from preexisting control processing components. In such case, there may have existed interoperability structures between processor 212 and a control stream inserter (122, 152 in FIGS. 6 and 7, respectively). In such case, it may be expeditious to continue to use such propriety or standard structures. In a newly developed system, processor 212 may optionally be combined with the batch aggregator, since in a newly developed system preexisting interoperability structures may not need to be accommodated. Either structure and either mode of operation are considered to be within the scope of the present invention. In either case, batch aggregation of the control instructions with the receiver and device addresses having been rendered in serial number format by processor 212, will occur at the MCP 102. When complete, the batch is emailed to the appropriate uplink from batch aggregation 224. While it is also considered to be within the scope of the present invention that session communications could execute the transmission of control instruction commands from a master control processor to remote uplinks, in the depicted embodiment batch mode is found to be advantageous because it enhances interoperability with firewalls and the like.

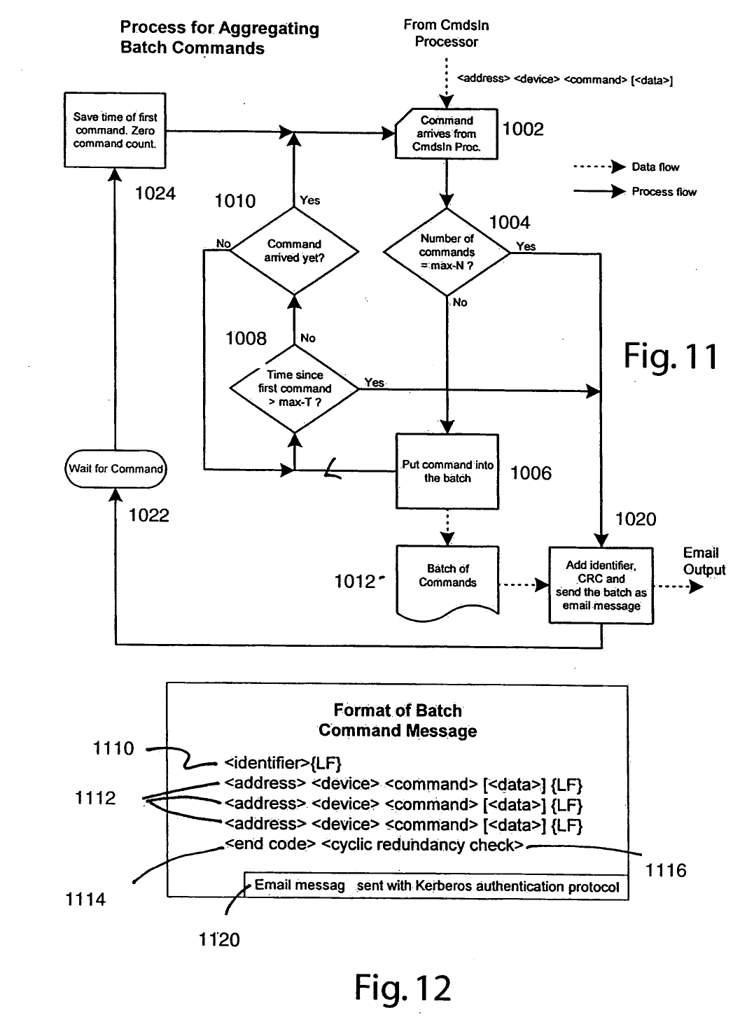

Batches are aggregated as follows. FIG. 11 is a flow chart depicting the process. From processor 212, a control instruction command is received 1002. Generally, it remains in ASCII human readable format, with the exception that the receiver address and device address have been replaced with serial numbers corresponding to the unique receiver and device.

Batches are sent at the earlier of two events. The first event is that a preconfigured batch volume has been reached. The second event is that a preconfigured time out has been reached, in order that control instruction commands are not unduly delayed due to low activity. The maximum volume of a batch is designated “max N.” The preconfigured time out is designated “MAX T.” After a control instruction command has been received 1002, it is checked to see if that command in addition to the commands already in a batch being assembled, meets “MAX N.” If not, the command is put into batch 1006.

The process flow then proceeds to check the time since the first command was entered into the batch at 1008. If it MAX T has not been reached, the process flow asks if any command has been received yet 1010. If not, the time is checked again. If yes the processor receives the next command at 1002.

Once either MAX N or MAX T has been reached, the batch of commands, stored at 1012 is operated upon. The operation includes adding a batch identifier, and a cyclic redundancy check (CRC) 1020. The batch is sent 1020. If the number of commands equaled MAX N at step 1004, step 1020 is also executed and an email sent.

After the email has been sent, the process waits for a next command 1022. When a next command is received 1024, the time of receipt is saved and the command count is zeroed. Accordingly, a new MAX T and a new MAX N may be calculated.

FIG. 12 illustrates the format of the actual control instruction command. It is an email in batch mode. A first portion 1110 is an arbitrary identification number for the particular batch. Each line but the last will end in a line feed, simply indicating another line and indicated in the drawing as {LF}. Hereafter the actual control instructions are sent. They remain in the modified ACSII format, with the receiver and device addresses being registered as serial numbers 1112. An end code is designated at 1114. Thereafter a CRC 1116 is sent and executed upon receipt. In the depicted embodiment an authentication protocol 1118 is included in the control instruction command and emailed for security. This may be any authentication protocol. In the depicted embodiment it is the Kerberos authentication protocol.

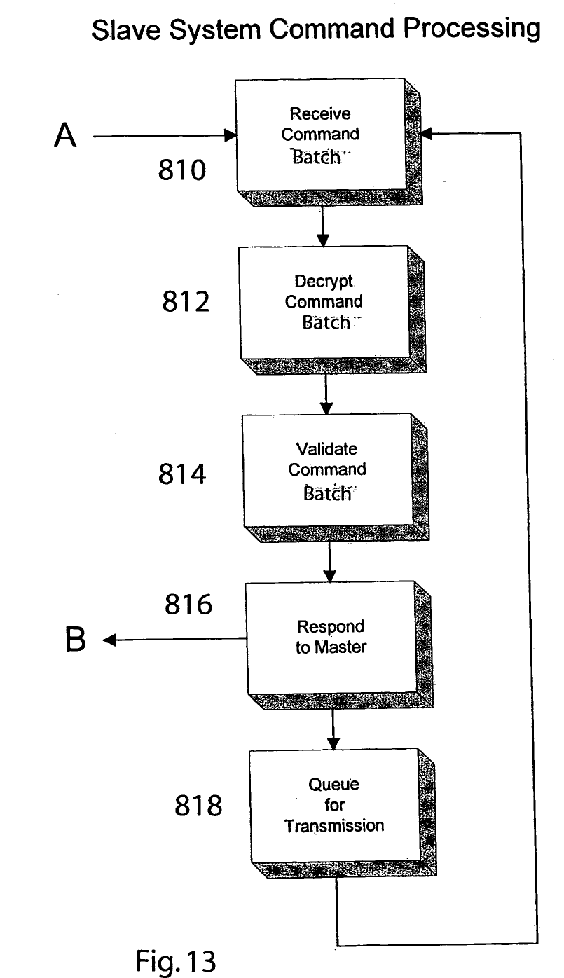

FIG. 13 is a flow chart of a “slave” uplink's command processing. The slave uplink receives a control instruction command email 810 from the master control processor. The control instruction command email is designated “command structure” in FIG. 13. The email is decrypted 812 and validated 814. A confirming email is sent 816, and the control stream inserter queues the control instructions for transmission in the outgoing stream for broadcast at 818.

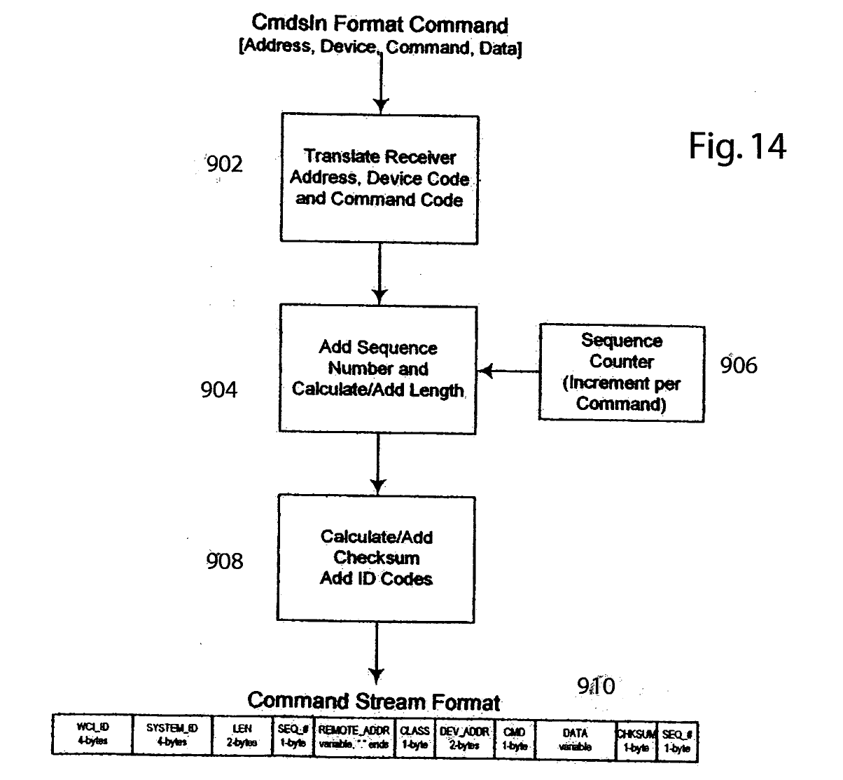

As further illustrated in FIG. 14, in a flow chart for assembling a control instruction packet, the following steps are executed. A sequence number is added to the command stream format 904. This data is translated 902 to a MPEG DVB (or other protocols) binary compilation for insertion into the transport data stream. The result of this translation, which is the same process used when the control processor is integrated with the uplink unit, is the Stream Format, as described below. The sequence number is generated by a sequence counter 906 in a known fashion also used for all broadcast data packets. A check sum is calculated and added 908. The Stream Format is inserted 910. The sequence number is received from the sequence counter which is incremented per command. Thereafter a check sum will be calculated and added to the command stream format.

Control Instructions

The control stream inserter 122, 152 (FIGS. 6, 7, respectively) receives the control instructions in modified ASCII format with “address/device/command/data specified.

As discussed above, a sample control instruction for immediate execution would include a receiver address, which may be the address of an individual receiver or group of receivers. It would further include a device address identifying the component of the receiver affected by the control instruction. The control instructions would further include a command to play the media content data. A DVB bitstream contains these control instructions in a packet with a header and also a data payload comprised of the instructions themselves.

A more complicated control instruction would be a scheduled instruction to play programming at a scheduled time. Such a control instruction stream would include month, day and year information, hour or minute and second information, and then be followed by the other parameters discussed above; receiver address, device address, play command and identification of the media content data itself.

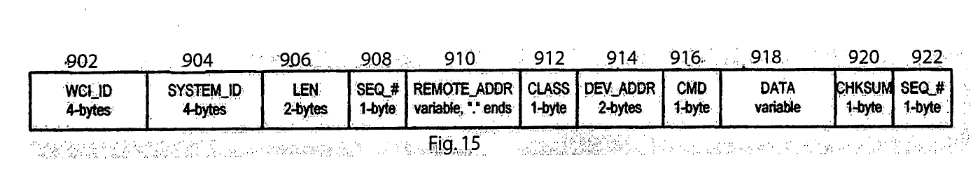

FIG. 15 illustrates the output format control instruction packet stream to be inserted into the DVB bit stream forwarded for transmission. First a four byte frame separator “WCI_ID” is written at position 902 in hexidecimal format, ie “WCI&”. A 4 byte system_ID for example “STNT” is entered at position 904. A 2 byte length indicator LEN is entered at position 906, for example “OFH” indicates the number of bytes from the sequence number through the end of the data payload “918”. Next, at position 908 a 1 byte sequence number, SEQ_{—}# “01H” identifies the serial number of the control instruction packet. At position 910, the remote address of the individual receiver is given, for example “S157301.” At position 912 a class identifier of 1 byte is given, for example “00H.” It is at this position that the type of control instruction packet is identified as either for immediate execution or scheduled or periodic execution. As indicated above, these scheduled control instructions are retained at an uplink database and executed through a scheduler for insertion into the data transport stream. Position 914 contains the device address “DEV_addr” which may, for example, be “001DH,” indicating an MPEG decoder selection. At position 916 a 1 byte command, “CMD” codes the actual command identifying the parameter to be controlled. For example, “09H” would code the audio level parameter for execution of a control instruction. At position 918 the size is variable depending on the complexity of the control instruction, the actual data reflecting the option or level of the parameter to be controlled is coded. For example, “01H, 06H” would set port number 1 to six decibels, to control the audio level output by the MPEG decoder. At position 920, 1 byte check sum, for example “51H” is sent. The packet terminates at position 922 with a repeat of the sequence number, SEQ_{—}# “01H.”

The receiver decodes and separates these control instruction packets from the overall digital content bit stream and executes them in known fashion.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A control system for media content data broadcast comprising:
a control processor operatively associated with a web server, said control processor and said web server each having communication links to a computer network;
at least one uplink, said uplink being remote from said control processor and said uplink being operatively connected to said computer network;
said control processor being configured to receive control instruction requests through said communication link with said computer network;
said control instruction requests being entered through a remote communication link with said computer network; and
said control processor being further configured to generate a control instruction command and to control transmissions made by said at least one uplink by sending to said at least one uplink said control instruction command through said computer network.

2. A control system of claim 1 wherein said computer network is the Internet.

3. The control system of claim 1 wherein said control instruction command is sent in batch mode.

4. The control system of claim 1 wherein said control instruction command is sent in session mode.

5. The control system of claim 1 wherein said control instruction requests are sent in session mode.

6. The control system of claim 1 wherein control instructions include at least one control instruction selected from the group consisting of:
advance scheduling and periodic scheduling.

7. A broadcast satellite uplink for transmitting media content data to a satellite for broadcast to a plurality of receivers comprising:
an encoder for encoding a digital video broadcast bitstream stream in a transmittal format;
a multiplexer;
a transmitter;
a control inserter being configured to receive control instruction commands via email from a remote control processor, and said control inserter being further configured to encode into a digital video broadcast bitstream control instructions taken from said control instruction command email; and
an email communication link between said control inserter and a computer network.

8. A control processor for satellite broadcast of media content data comprising;
a control processor being configured to build control instruction commands, said control instruction commands being executable by an uplink for transmission of a digital video broadcast bitstream including control instructions contained within said control instruction command;
said control processor being in operative communication with a web server such that control instruction requests are received by said control processor after said requests are received by said web server in an HTTP transmission from a remote web browser;
said control processor being further configured to package control instructions from said control instruction requests in an email to at least one remote uplink; and
a communication link to a computer network, said communication link allowing said control instruction command to be emailed to remote uplinks.

9. The control processor of the previous claim wherein said communication link further allows confirmation message from said at least one remote uplink back to said control processor via email.

10. A method of controlling a media content broadcast comprising:
receiving a control instruction request at a central processor from a remote input, through a computer network linked to both said central processor and said remote input;
generating a control instruction command, said control instruction command being configured to be executable by an uplink for transmission of the control instructions to a plurality of remote receivers via satellite, said uplink being remote from said central processor; and
sending said control instruction command to the uplink through said computer network, said uplink also being linked to said computer network.

11. The method of claim 10 wherein said computer network is the internet.

12. The method of claim 10 wherein said sending step is in batch mode.

13. The method of claim 10 wherein said sending step is in session mode.

14. The method of claim 10 wherein said control instruction command includes scheduling.

15. A machine readable data structure for remote control of media content broadcasts comprising:
a control instruction set, said control instruction set being configured to be executable by a receiver upon its receipt via broadcast, said control instruction set being further configured to be embedded in a control instruction command,
said control instruction command being adapted to be sendable through a computer network from a control processor linked to the computer network to a satellite uplink also linked to the computer network;
a correlation indicator, identifying a unique user and correlating at least one of a plurality of receivers with the unique user; and
said control instruction command being configured with a network transfer protocol to send said control instruction set and said correlation indicator over the computer network at a user signal to the control processor for sending to the control instruction command.

16. The system of claim 1 wherein said control processor links to said computer network via a protocol selected from the group consisting of:
SMTP, HTTP, FTP, and TFTP.

17. The system of claim 1 further comprising a graphical user interface with said control processor.

18. The system of claim 1 wherein said control processor operates on Unix.

19. The system of claim 1 wherein said link between said control processor and said computer network is an Ethernet/LAN link.

20. The system of claim 1 wherein said control processor is associated with said web server via a socket server.

21. The system of claim 1 further comprising a status memory in operative communication with said control processor.

22. The system of claim 21 wherein said status memory records a receiver status and user status.

23. The system of claim 21 further comprising an update driver, said update driver being configured to update said status memory to record a current status.

24. The system of claim 1 further comprising a batch aggregator in operative communication with said control processor.

25. The system of claim 24 wherein said batch aggregator and said control processor are separate components.

26. The system of claim 24 wherein said batch aggregator is configured to complete a batch for transmission upon obtainment of a preconfigured batch volume.

27. The system of claim 24 wherein said batch aggregator is configured to complete a batch for transmission upon reaching a preconfigured time out.

28. The system of claim 1 wherein said control processor and said web server communicate via a language selected from the group consisting of:
Perl, TCL, C, C++, or Visual Basic.

29. The system of claim 1 wherein said uplink further comprises a control stream inserter.

30. The system of claim 1 wherein said uplink further comprises a firewall.

31. The control system of claim 1 wherein said web server further comprises a firewall.

32. The system of claim 1 wherein said uplink further comprises an encoder and a multiplexer.

33. The system of claim 1 wherein said uplink further comprises an audiovisual input device.

34. The system of claim 33 wherein said audiovisual input device is a live feed.

35. The system of claim 1 further comprising a schedule memory.

36. The system of claim 35 wherein said schedule memory is located at said uplink.

37. The system of claim 35 wherein said schedule memory is located at said control processor and in operative communication with said control processor.

38. The system of claim 1 wherein said uplink is a conventional uplink, said conventional uplink further comprising a separate control processor.

39. The system of claim 1 wherein said control instruction request includes a receiver address, a device address, a control parameter and a parameter data.

40. The system of claim 1 further comprising default control instructions stored in a memory exit, said memory being operatively accessible by said control processor.

41. The system of claim 1 further comprising an activity log.

42. The system of claim 41 wherein said activity log is searchable.

43. The system of claim 1 wherein said control instruction request is encrypted.

44. The system of claim 1 wherein said control instruction command is encrypted.

45. The system of claim 1 wherein said control instruction command includes receipt confirmation instructions.

46. The system of claim 1 wherein said control instruction command includes no-error confirmation instructions.

47. The system of claim 46 wherein said control processor is configured to resend a control instruction command if a no-error confirmation is not received.

48. The system of claim 1 wherein said control processor is configured to update a status memory if a no-error confirmation message is received from said uplink.

49. The system of claim 1 wherein said control instruction request includes an instruction to schedule transmission of control instructions at a later selectable time.

50. The system of claim 1 wherein said control instruction command includes a control instruction packet.

51. The system of claim 50 wherein said control instruction packet includes a frame separator, a system identification, a length indicator, a sequence number, a remote address for an individual receiver, a class identifier, a device address, a command identifier, a command data value and a check sum.

52. The system of claim 1 wherein said control instruction request includes a control instruction packet.

53. The system of claim 52 wherein said control instruction packet includes a frame separator, a system identification, a length indicator, a sequence number, a remote address for an individual receiver, a class identifier, a device address, a command identifier, a command data value and a check sum.

54. A webpage data structure comprising:
a plurality of pages, each page associated with a system user, and each page being accessible by a unique password associated with one system user;
said web page data structure being further configured to access control instruction screens and a status memory for content distribution on a satellite media distribution system.

55. The web page data structure of claim 54 further comprising a log of current control parameter settings.

56. The web page data structure of claim 54 further comprising a command queue display.

57. The web page data structure of claim 54 further comprising a receiver control parameter page.

58. The web page data structure of claim 54 further comprising a content status page.

59. The web page data structure of claim 58 wherein said content status page includes advertisement data and play interval data.

60. The web page data structure of claim 54 being further configured to send control instruction requests in an encrypted form.

61. The web page data structure of claim 54 further configured to associate separate uplink parameter displays with a particular uplink.

62. The web page data structure of claim 54 further configured to associate particular control instructions with particular corresponding receivers.

63. The web page data structure of claim 54 further comprising a review window.

64. The web page data structure of claim 54 further comprising a confirmation screen.

65. The web page data structure of claim 54 being further configured to prioritize pages according to a priority selected from the group consisting of:
customers, cable providers, channels, satellites and programming.

66. A machine readable data structure for remote control of media content broadcasts comprising:
a control instruction set, said control instruction set being configured to be executable by a receiver upon its receipt via broadcast, said control instruction set being further configured to be imbedded in a control instruction request;
said control instruction request being adapted to be sendable through a computer network from a webpage access site linked to the computer network and to a control processor also linked to the computer network;
a correlation indicator, adapted to identify a unique user and correlating at least one of a plurality of receivers with the unique user; and
said control instruction request being configured with a network transfer protocol to send said control instruction set and said correlation indicator over the computer network at a user signal to the remote webpage access site for sending the control instruction request.
